(19) United States
(12) Patent Application Publication
(10) Pub. No.: US 2007/0285886 A1
(43) Pub. Date: Dec. 13, 2007

(54) Desktop computer setup

(76) Inventor: Rong-Huei Huang, Xinzhu County (TW)

Correspondence Address: BACON & THOMAS, PLLC, 625 SLATERS LANE, FOURTH FLOOR, ALEXANDRIA, VA, 22314, US

(21) Appl. No.: 11/447,842

(22) Filed: Jun. 7, 2006

(51) Int. Cl. G06F 1/20; G06F 1/16

(52) U.S. Cl. 361/687; 361/683

(57) ABSTRACT

A desktop computer setup with an LCD embedded into a side casing which is disposed on the wide side of the host case. There is more than one speaker, optical drive, and floppy drive, as well as one modem, and one main switch also embedded into the side casing around LCD. The inner part of a frame located inside the host case not only provides all slots for the components described above, it also holds a motherboard, a power supply, and at least one fan. There is also one I/O port on the other wide side of the case, as well as one on the narrow sides. Finally, the bottom of the case is equipped with a keyboard holder that can be drawn out in the direction of the LCD.

### FIELD OF THE INVENTION

The present invention relates to a desktop computer setup, and more particularly to a structure which combines the computer host with the display device.

### BACKGROUND OF THE INVENTION

A typical desktop computer setup currently comprises a computer host, an LCD, and some peripherals such as mouse, keyboard, speakers, modem, and printer. Since all these devices are plug-n-play enabled and require a cable connection for operation, the desktop can become the big mess of cables that we're accustomed to. Especially at the back of the computer, there are almost 10 cables: power cables and/or data cables for the system, monitor, speakers, modem, printer, mouse, and keyboard. The case worsens if other electronic devices, such as a telephone or computer external add-ons are nearby, and when these cables start to collect dust over time, it can be a hassle to clean them. For amateur users who prefer not to tamper with the wires, this causes a healthy problem. Therefore, by combining certain components, the number of cables can be decreased and organized, further facilitating the use of the system. To come up with a practical solution, the inventor has conducted the research and development needed to address these problems.

### SUMMARY OF THE INVENTION

The primary objective of this invention is to provide a desktop computer setup that is space-efficient, easy to clean and assemble, more aesthetically appealing, and easier to use. Thus, the computer host and the LCD has been combined into one unit, thereby eliminating the need for a stand for the monitor, while the host can simply be placed on the original location of the monitor.

The secondary objective of this invention is to further save space by including a compartment for the keyboard and further having a sliding keyboard holder. The holder can be drawn out from under the host when the keyboard is in use, and it can be inserted back into the host when the keyboard is not in use. This effectively minimizes the desktop space needed for the keyboard, making the desktop system almost as convenient as a laptop.

To achieve aforementioned objectives, the present invention comprises one host case that has a side casing on one wide side with embedded LCD. There is more than one speaker, optical drive, and floppy drive, as well as one modem, and one main switch also disposed on the side casing around the LCD. The inner part of a frame which is inside the host case not only provides all slots for the components described above, it also holds a motherboard, a power supply, and at least one fan. There is also one I/O port on the other wide side of the case, as well as one on the narrow sides. Finally, the bottom of the case is equipped with a keyboard holder that can be drawn out in the direction of the LCD.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a pictorial drawing of the present invention;

FIG. 2 is an exploded pictorial drawing of the present invention;

FIG. 3 is an exploded end view of the side casing and the host case for the present invention;

FIG. 4 is another end view of the host case without the side casing;

FIG. 5 is a front view of the host case without the side casing; and

FIG. 6 is a rear view of the host case.

### DETAILED DESCRIPTION OF THE PREFERRED EMBODIMENTS

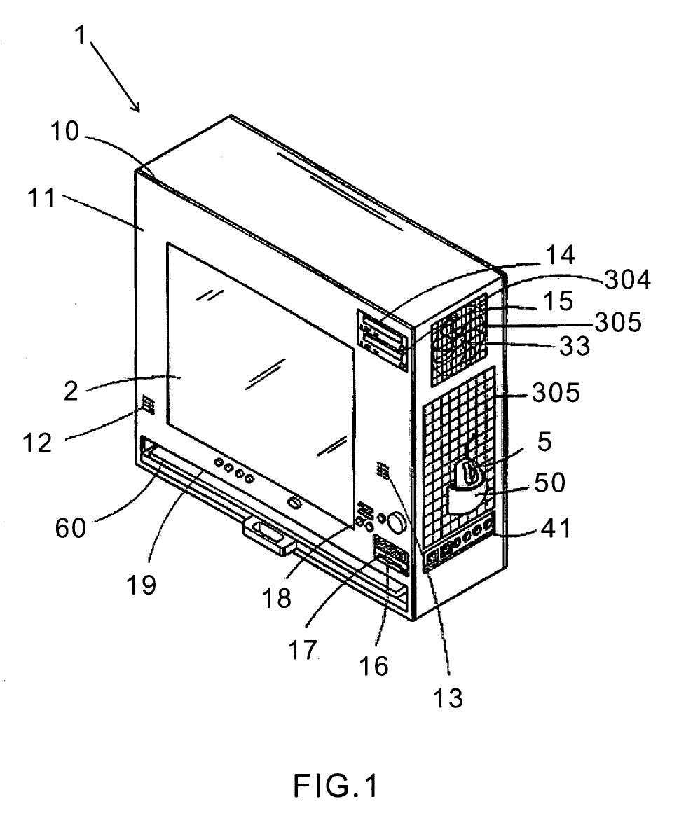

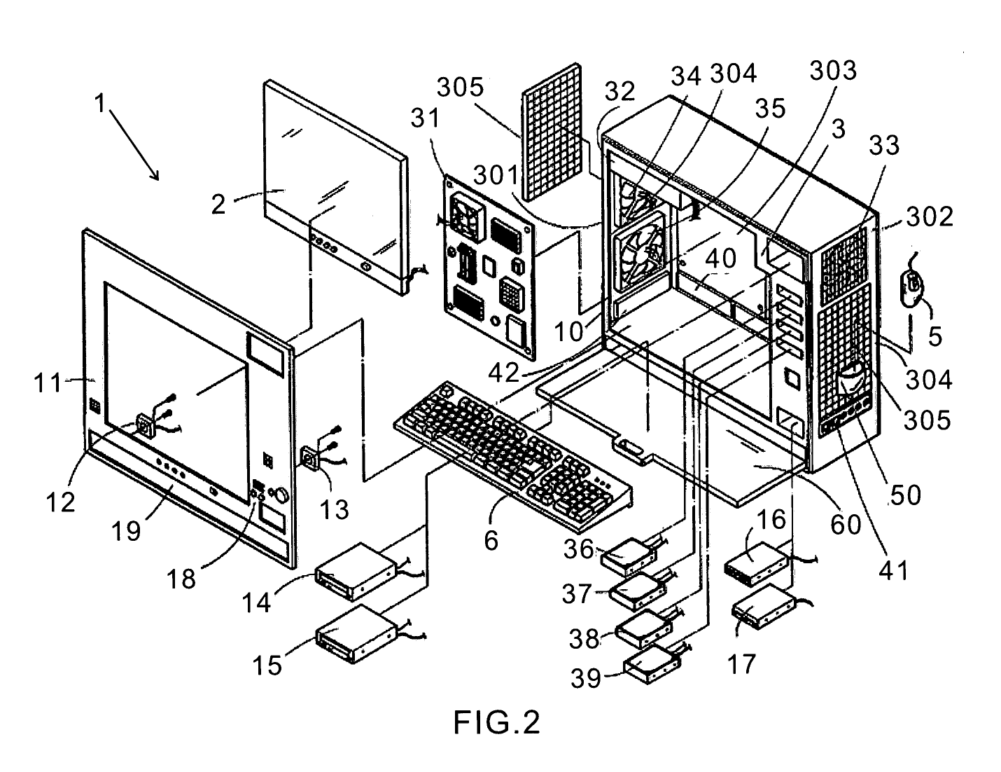

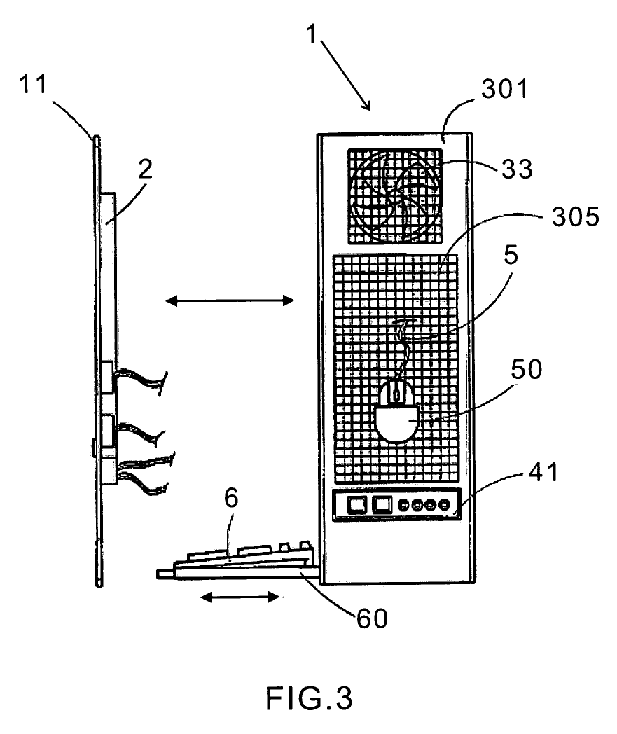

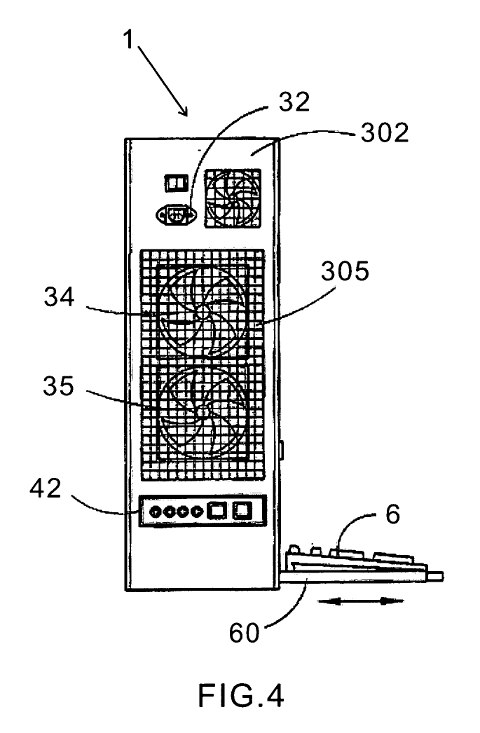

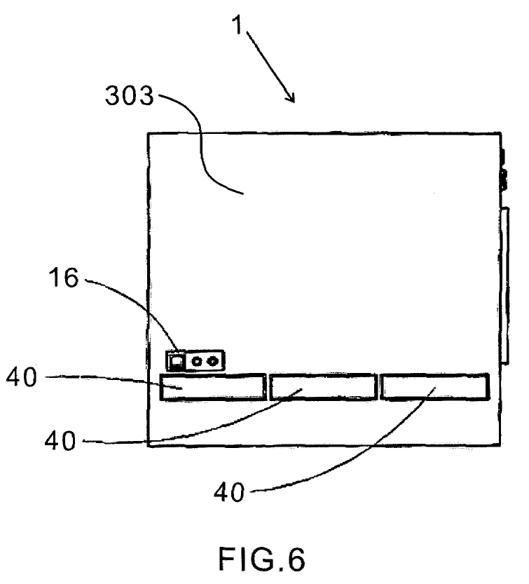

As shown in FIGS. 1 to 6, a desktop computer of the present invention comprises a host case 1. On its wide side 10 is a side casing 11 that has an embedded LCD 2 with speakers 12 and 13, one or more optical drives 14 and 15, one or more floppy drives 16, one or more modems 17, and one main switch 18. The inside of the host case 1 is a frame 3. The inner part of the frame 3 not only provides all slots for the components on the side casing 11, it also holds a motherboard 31, a power supply 32, and at least one fan 33, 34 and 35, and at least one hard drive 36, 37, 38, and 39. The narrow side 301 of the frame 3 has a power supply 32 and two fans 34 and 35, while its oppositely narrow side 302 has one fan 33 and an air vent 304. And the air vent 304 has a filter 305 built-in. The other wide side 303 of the host case 1 has I/O ports 40, while the narrow sides 301 and 302 also have I/O ports 41 and 42. On the narrow side 301 of the host case 1, there is a mouse holder 50 that can hold a mouse 5 when not in use. There is an opening 19 on the host case 1 which beneath the LCD 2 for entering a keyboard 6. As shown in FIGS., a keyboard holder 60 disposed on the bottom of frame 3 can be drawn out in the direction of the LCD 2.

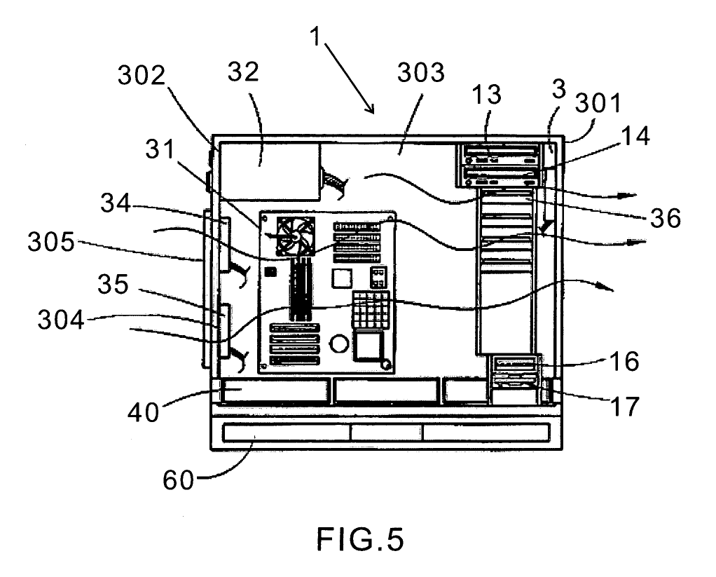

As shown in FIG. 5, this invention has 3 fans 33, 34 and 35 to circulate the airflow inside the computer, which will have a more complex set of cables due to the added components. However, this does not change the orientation of the motherboard 31, but only changes the conformation of the frame 3 because it is now closer to one side of the system. There are also some ventilation holes disposed on the narrow side 301 and 302, with easy latching-on of hard drives 36, 37, 38, and 39.

The side casing 11 in the present invention can also be hinged with the wide side 10 of the host case 1 at a 90-degree angle. The side casing 11 can be opened and closed to help it lock onto the host case 1 to protect the cables from tearing.

As described in details above, the present invention applies the principles of saving space, combining components, and hiding more than half the cables inside the host case 1 to improve appearance and facilitate use. This effectively eliminates some of the sanitary problems previously mentioned. Not only does the computer save space and is more pleasing to the eye, it also has a more wholesome feel to it. When a component is needed, simply extract it from the system, and place it back when finished. For the user, the desktop computer is a more portable device that is easier to use and different from the traditional ones.

The present invention has been clarified with those preferred embodiment described above; however, it is not intended to limit the scope of the present invention. Any equivalent modification and variation according to the spirit of the present invention is to be also included within the scope the claims of the present invention.

What is claimed is:

1. A desktop computer setup, comprising a host case and a side casing disposed on a wide side of said host case; an LCD being embedded into said side casing, and more than one speaker, optical drive, and floppy drive, as well as one modem, and one main switch also being embedded into said side casing around said LCD; a frame inside said host case not only providing all slots for said components described above, said frame also holding a motherboard, a power supply, and at least one fan; a port connector being disposed on the other side of said host case, as well as one on the narrow sides.

2. The desktop computer setup according to claim 1, wherein a fan is installed on the opposite side to the narrow side with said power supply.

3. The desktop computer setup according to claim 1, wherein a pair of fans are installed on the same side to the narrow side with said power supply, with a air vent and a built-in filter on the opposite side.

4. The desktop computer setup according to claim 1, wherein a mouse holder is disposed on one of said narrow sides of said host case.

5. The desktop computer setup according to claim 1, wherein an opening is disposed underneath said LCD for entering said keyboard.

6. The desktop computer setup according to claim 1, wherein a keyboard holder is disposed near the bottom of said frame in said host case, and said keyboard holder can be drawn out in the direction of said LCD.
